(19) United States
(12) Patent Application Publication
(10) Pub. No.: US 2026/0318583 A1
(43) Pub. Date: Oct. 15, 2026

(54) MULTIFUNCTIONAL VACUUM DEVICE

(71) Applicant: Shenzhen Kaiswei Technology Co., Ltd., Shenzhen (CN)

(72) Inventor: Yongbing Fan, Shenzhen (CN)

(21) Appl. No.: 19/175,453

(22) Filed: Apr. 10, 2025

(51) Int. Cl. F25D 17/04

(52) U.S. Cl. CPC F25D 17/042; F25D 2317/043

(57) ABSTRACT

The application discloses a multifunctional vacuum pump, comprising a shell, an intelligent control system, which is arranged at the top of the housing and extends to the top of the housing; a micro vacuum pump, which is arranged at the top of the housing and is located below the intelligent control system; a covering sealing interface: through an externally pressed silicone sealing ring, elastic deformation is used to adapt to a 65-100 mm caliber container, and it is compatible with a variety of materials such as glass/metal/plastic; zero-damage operation: the plug-in cover opening design replaces the traditional prying operation, the installation steps are simple, and the service life of the sealing ring is improved.

### FIELD OF THE APPLICATION

The present application relates to the technical field of vacuum devices, and in particular to a multifunctional vacuum device.

### BACKGROUND

Traditional vacuum devices, such as food preservation and red wine storage equipment, generally adopt a “sleeve-type seal” structure, which requires the sealing ring to be forcibly embedded in the container mouth to achieve sealing. This type of design has significant defects:
Poor compatibility: The sealing ring must strictly match the container diameter, such as 65 mm or 100 mm fixed specifications, and cannot be adapted to special-shaped or large-sized containers;
Complicated operation: When installing, the container mouth must be pried open with tools, which can easily cause the sealing ring to wear or the container to deform, and the breakage rate is high;

Therefore, in response to the above problems, a multifunctional vacuum device is designed.

### SUMMARY

A multifunctional vacuum device, comprising a shell, an intelligent control system, a micro vacuum pump, a battery pack and a sealing component; the intelligent control system is arranged at the top of the shell and extends to the top of the shell; wherein the micro vacuum pump is arranged at the top of the shell and is located below the intelligent control system; wherein the battery pack is arranged in parallel in the shell and supplies power to the intelligent control system and the micro vacuum pump; the bottom of the shell is provided with a socket, the lower end of the socket is provided with a silicone sealing ring in a detachable manner, and the bottom of the shell is provided with an air pipe, the lower end of the air pipe is connected to the inside of the socket; wherein the sealing component and the silicone sealing ring are connected and matched.

The intelligent control system includes a main control circuit board, a power switch and a negative pressure switch; the main control circuit board is arranged at the top of the shell, the power switch is arranged at the upper part of the shell and connected to the main control circuit board through a line, and the negative pressure switch is arranged at the upper part of the shell and connected to the negative pressure switch through a line.

The sealing component comprising a fixed silicone part, a vacuum seal silicone plug, a large flat silicone seal and a small flat silicone seal; wherein an inner tube is provided in the middle of the fixed silicone part, an edge is provided on the upper part of the inner tube, the large flat silicone seal is clamped on the fixed silicone part, and the large flat silicone seal is located at the lower part of the edge, a mounting hole is provided at the bottom of the inner tube, the vacuum seal silicone plug is installed in the mounting hole, one end of the vacuum seal silicone plug is located in the inner tube, and the other end of the vacuum seal silicone plug extends to the outside of the inner tube, a small flat silicone seal is pressed on the fixed silicone part, and the large flat silicone seal and the small flat silicone seal are respectively located at both ends of the fixed silicone part.

The lower end of the sleeve is provided with an installation groove, and one end of the silicone sealing ring is installed in the installation groove.

The sleeve is provided with a lower cover outside.

The upper part of the shell is provided with a Type-c fast charging port.

The advantages of the present invention compared with the prior art are:
Full-caliber dynamic sealing
Covering sealing interface: through external pressing of silicone sealing ring, elastic deformation is used to adapt to 65-100 mm caliber containers, and it is compatible with various materials such as glass/metal/plastic;
Zero-damage operation: the plug-in opening design replaces the traditional prying operation, the installation steps are simple, and the life of the sealing ring is improved;
One machine for multiple uses: breaking through the traditional preservation field, it can encapsulate laboratory samples, medicines, and precision electronic components;
Dynamic pressure feedback: breaking through the static adaptation limitations of traditional silicone sealing rings, and improving the sealing reliability through dynamic pressure feedback.
Intelligent energy-saving system
Adaptive air extraction algorithm: the main control circuit board dynamically adjusts the micro pump power according to the container volume, which is more energy-saving;
60 seconds automatic shutdown: prevent excessive vacuuming from causing container deformation and reduce the breakage rate.

### BRIEF DESCRIPTION OF THE DRAWINGS

FIG. 1 is a schematic diagram of the three-dimensional structure of a multifunctional vacuum pumping device of the present invention.

FIG. 2 is a front view of a multifunctional vacuum pumping device of the present invention.

FIG. 3 is a schematic diagram of the three-dimensional structure of a multifunctional vacuum pumping device of the present invention when viewed from above.

FIG. 4 is a schematic diagram of the structure of a multifunctional vacuum pumping device of the present invention in a disassembled state.

FIG. 5 is a front view of a sealing component of a multifunctional vacuum pumping device of the present invention.

FIG. 6 is a schematic diagram of the three-dimensional structure of a sealing component of a multifunctional vacuum pumping device of the present invention.

FIG. 7 is a front view of a sealing component of a multifunctional vacuum pumping device of the present invention in an exploded state.

FIG. 8 is a three-dimensional view of a sealing component of a multifunctional vacuum pumping device of the present invention in an exploded state.

FIG. 9 is a three-dimensional view of a multifunctional vacuum pumping device of the present invention in an exploded state.

FIG. 10 is a cross-sectional view at A-A in FIG. 2.

FIG. 11 is a cross-sectional view at B-B in FIG. 5.

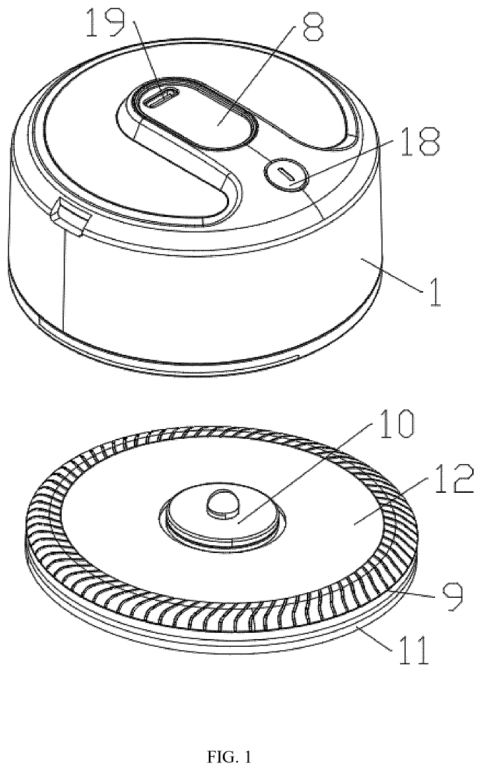

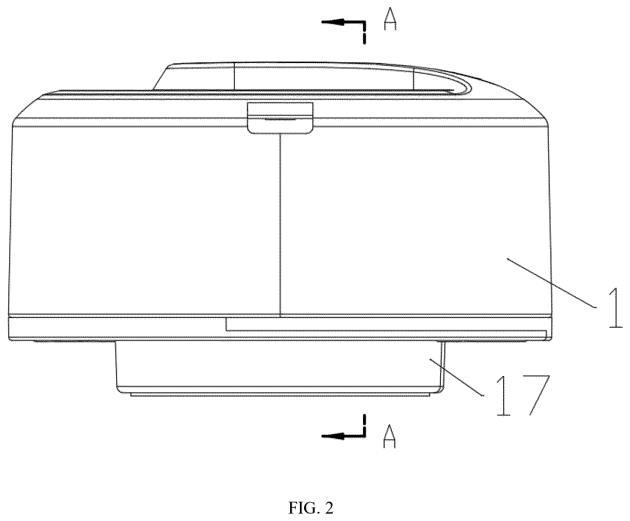

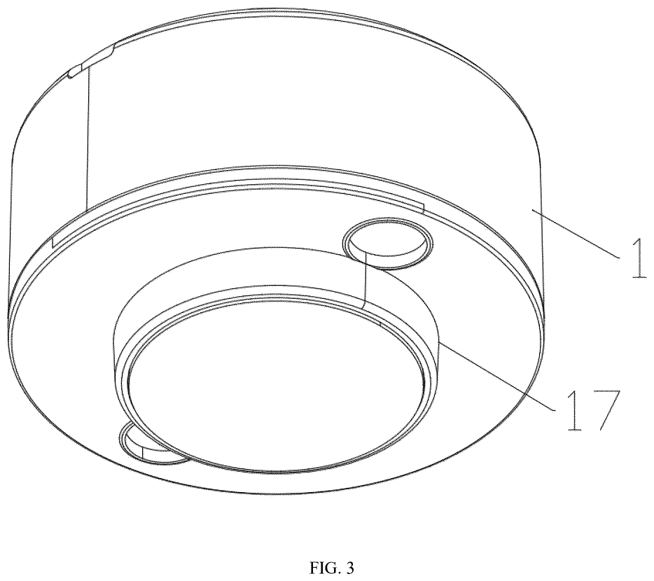

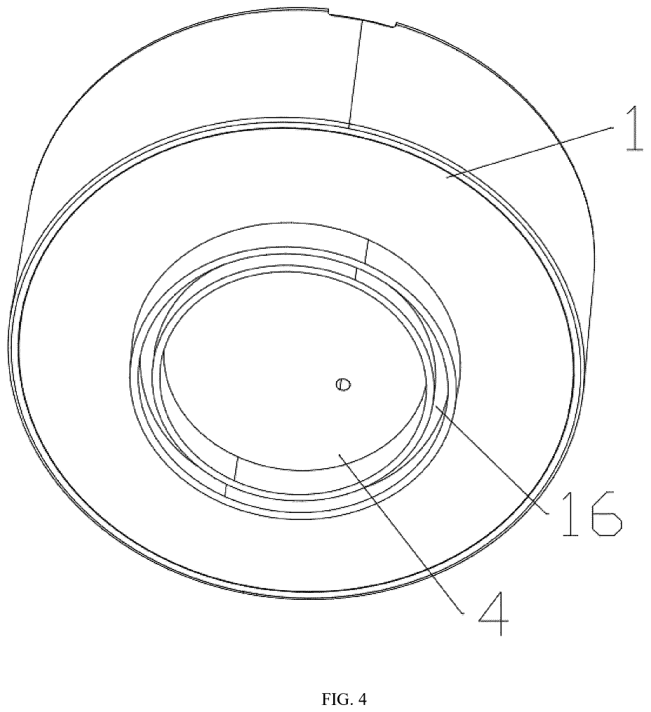

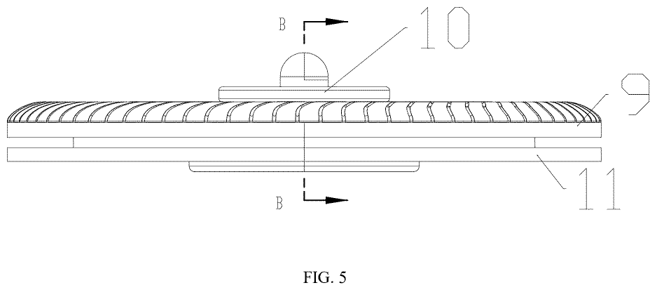

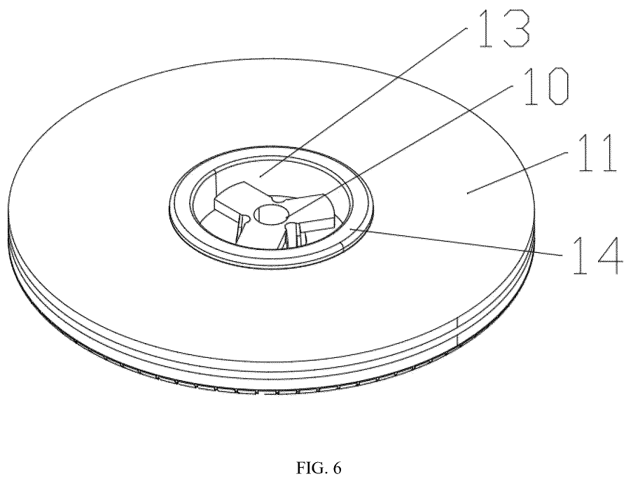

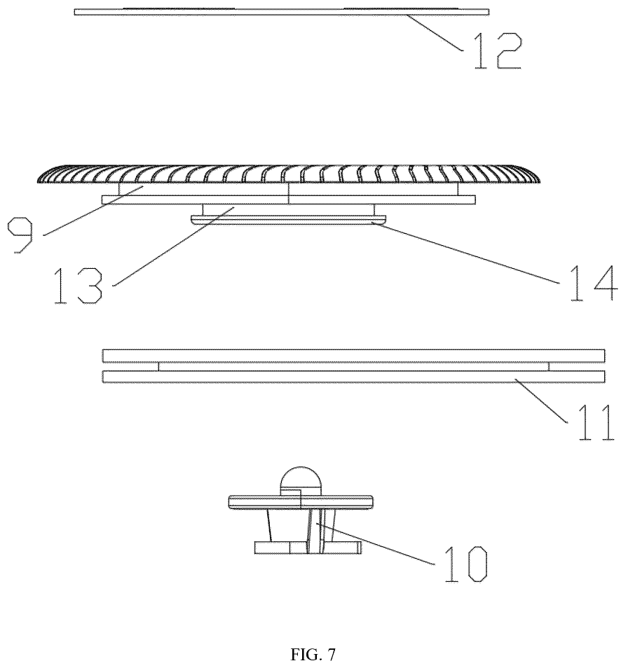

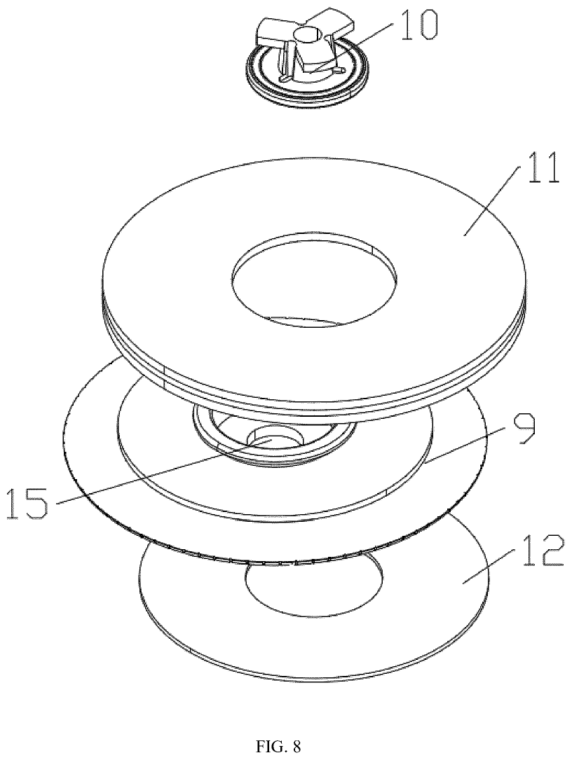

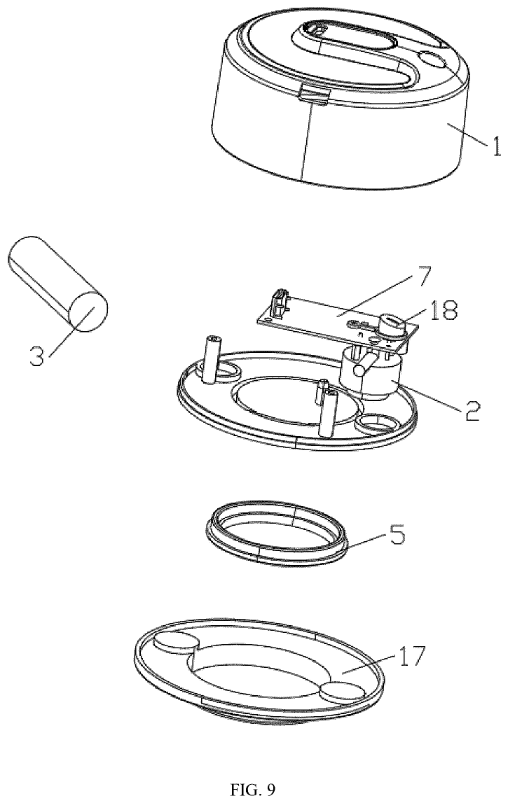

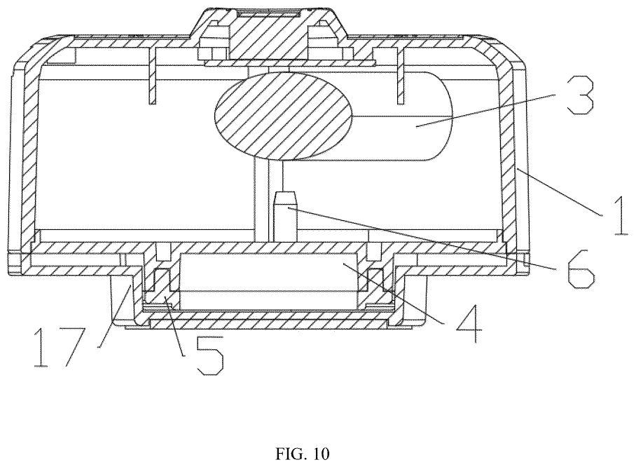

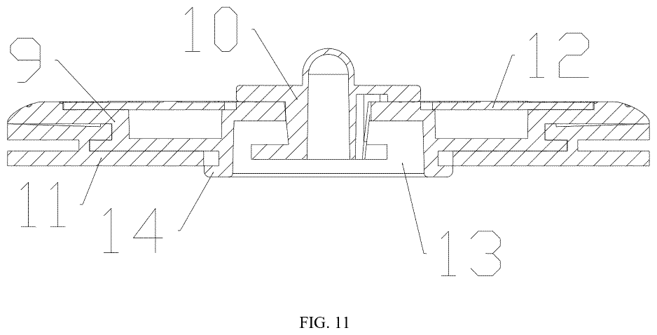

As shown in FIGS. 1-11:
1. Shell
2. Micro vacuum pump
3. Battery pack
4. Socket
5. Silicone sealing ring
6. Air pipe
7. Main control circuit board
8. Power switch
9. Fixed silicone parts
10. Vacuum seal silicone plug
11. Large flat silicone seal
12. Small flat silicone seal
13. Inner tube
14. Edge
15. Mounting hole
16. Mounting groove
17. Lower cover
18. Negative pressure switch
19. Type-c fast charging port

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION OF EMBODIMENTS

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology. All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

As shown in FIG. 1-11, A multifunctional vacuum device, comprising a shell 1, an intelligent control system, a micro vacuum pump 2, a battery pack 3 and a sealing component; the intelligent control system 1 is arranged at the top of the shell and extends to the top of the shell 1; wherein the micro vacuum pump 2 is arranged at the top of the shell 1 and is located below the intelligent control system; wherein the battery pack 3 is arranged in parallel in the shell 1 and supplies power to the intelligent control system and the micro vacuum pump 2; the bottom of the shell 1 is provided with a socket 4, the lower end of the socket 4 is provided with a silicone sealing ring 5 in a detachable manner, and the bottom of the shell 1 is provided with an air pipe 6, the lower end of the air pipe 6 is connected to the inside of the socket 4; wherein the sealing component and the silicone sealing ring 5 are connected and matched.

The intelligent control system includes a main control circuit board 7, a power switch 8 and a negative pressure switch 18. The main control circuit board 7 is arranged at the top of the housing 1, the power switch 8 is arranged on the upper part of the housing 1, and is connected to the main control circuit board 7 through a line, the main control circuit board 7 is connected to the negative pressure switch 18 through a line, and the negative pressure switch 18 is arranged on the upper part of the housing 1.

The sealing component includes a fixed silicone part 9, a vacuum seal silicone plug 10, a large flat silicone seal 11 and a small flat silicone seal 12. An inner tube 13 is provided in the middle of the fixed silicone part 9, and an edge 14 is provided on the upper part of the inner tube 13. The large flat silicone seal 11 is clamped on the fixed silicone part 9, and the large flat silicone seal 11 is located at the lower part of the edge 14. A mounting hole 15 is provided at the bottom of the inner tube 13. The vacuum seal silicone plug 10 is installed in the mounting hole 15. One end of the vacuum seal silicone plug 10 is located in the inner tube 13, and the other end of the vacuum seal silicone plug 10 extends to the outside of the inner tube 13. A small flat silicone seal 12 is pressed on the fixed silicone part 9. The large flat silicone seal 11 and the small flat silicone seal 12 are respectively located at both ends of the fixed silicone part 9.

The lower end of the sleeve is provided with a mounting groove 16, and one end of the silicone seal ring 5 is installed in the mounting groove 16.

The socket 4 is provided with a lower cover 17 on the outside.

The upper part of the housing 1 is provided with a Type-C fast charging port 19, and the Type-C fast charging port 19 is connected to the battery pack 3 through a line.

When the present invention is implemented, sealing component workflow:
Step 1: Cover the sealing component on the container mouth through the sizeable flat silicone seal 11, remove the lower cover 17, align the sleeve 4, and press down the shell so that the silicone seal ring 5 is sleeved on the vacuum sealing silicone active plug 10;
Step 2: Start the power switch 8 barrel power supply, then turn on the negative pressure switch 18, start the micro vacuum pump 2 to evacuate through the air pipe 6, and the vacuum pressure triggers the vacuum sealing silicone active plug 10 to close;
Step 3: After the container reaches the target vacuum degree, the main control circuit board 7 starts the adaptive algorithm, adjusts the exhaust speed and activates the 60-second shutdown protection, which saves 37% energy compared with traditional equipment, avoids deformation of the tank body caused by excessive vacuum, and reduces the breakage rate from 25% to 0%;
Step 4: After the vacuum is completed, pull out the shell. The large flat silicone seal 11 and the small flat silicone seal 12 work together to maintain air-tightness.

Type-C fast charge +trickle protection circuit fully charged in 3 hours, cycle life ≥500 times, standby power consumption <0.05W.

Full charge can be used 100 times;

Can achieve stepless adaptation of 65-100 mm diameter;

Can be used for vacuuming red wine and fresh-keeping bags.

1. A multifunctional vacuum device, comprising a shell, an intelligent control system, a micro vacuum pump, a battery pack and a sealing component; the intelligent control system is arranged at the top of the shell and extends to the top of the shell;
wherein the micro vacuum pump is arranged at the top of the shell and is located below the intelligent control system; wherein the battery pack is arranged in parallel in the shell and supplies power to the intelligent control system and the micro vacuum pump; the bottom of the shell is provided with a socket, the lower end of the socket is provided with a silicone sealing ring in a detachable manner, and the bottom of the shell is provided with an air pipe, the lower end of the air pipe is connected to the inside of the socket; wherein the sealing component and the silicone sealing ring are connected and matched.

2. The multifunctional vacuum device of claim 1, wherein the intelligent control system includes a main control circuit board, a power switch and a negative pressure switch; the main control circuit board is arranged at the top of the shell, the power switch is arranged at the upper part of the shell and connected to the main control circuit board through a line, and the negative pressure switch is arranged at the upper part of the shell and connected to the negative pressure switch through a line.

3. The multifunctional vacuum device of claim 1, wherein the sealing component comprising a fixed silicone part, a vacuum seal silicone plug, a large flat silicone seal and a small flat silicone seal; wherein an inner tube is provided in the middle of the fixed silicone part, an edge is provided on the upper part of the inner tube, the large flat silicone seal is clamped on the fixed silicone part, and the large flat silicone seal is located at the lower part of the edge, a mounting hole is provided at the bottom of the inner tube, the vacuum seal silicone plug is installed in the mounting hole, one end of the vacuum seal silicone plug is located in the inner tube, and the other end of the vacuum seal silicone plug extends to the outside of the inner tube, a small flat silicone seal is pressed on the fixed silicone part, and the large flat silicone seal and the small flat silicone seal are respectively located at both ends of the fixed silicone part.

4. The multifunctional vacuum device of claim 1, wherein the lower end of the sleeve is provided with an installation groove, and one end of the silicone sealing ring is installed in the installation groove.

5. The multifunctional vacuum device of claim 1, wherein the sleeve is provided with a lower cover outside.

6. The multifunctional vacuum device of claim 1, wherein the upper part of the shell is provided with a Type-c fast charging port.
